(19) United States
(12) Patent Application Publication
(10) Pub. No.: US 2021/0197536 A1
(43) Pub. Date: Jul. 1, 2021

(54) MULTILAYER PROTECTIVE FILM

(71) Applicant: SAINT-GOBAIN PERFORMANCE PLASTICS CORPORATION, Solon, OH (US)

(72) Inventors: Tad BERGSTRESSER, Poway, CA (US); Luc A. GOEMAERE, San Diego, CA (US); Matthew GACEK, San Diego, CA (US)

(73) Assignee: SAINT-GOBAIN PERFORMANCE PLASTICS CORPORATION, Solon, OH (US)

(21) Appl. No.: 17/122,018

(22) Filed: Dec. 15, 2020

Related U.S. Application Data
(60) Provisional application No. 62/955,104, filed on Dec. 30, 2019.

(51) Int. Cl. B32B 27/08; B32B 27/36; B32B 7/12

(52) U.S. Cl. CPC B32B 27/08; B32B 27/36; B32B 7/12; B32B 2250/03; B32B 2307/58; B32B 2250/05; B32B 2255/10; B32B 2307/732; B32B 2250/04

(57) ABSTRACT

The present disclosure relates to a multilayer protective film that may include a multilayer component and a release liner component underlying the multilayer component. The multilayer component may have a first PET layer overlying a second PET layer. The multilayer protective film may further have a thickness ratio MPF_{T}:RL_{T} of not greater than about 14:1, where MPF_{T} is equal to the thickness of the multilayer component and RL_{T} is equal to the thickness of the release liner component.

### CROSS-REFERENCE TO RELATED APPLICATION(S)

This application claims priority under 35 U.S.C. § 119(e) to U.S. Provisional Application No. 62/955,104, entitled “MULTILAYER PROTECTIVE FILM,” by Tad BERGSTRESSER et al., filed Dec. 30, 2019, which is assigned to the current assignee hereof and is incorporated herein by reference in its entirety.

### FIELD OF THE DISCLOSURE

The present disclosure relates to a multilayer protective film and methods of forming the same, more particularly, the present disclosure relates to a multilayer protective film having a release liner with particular characteristics the improve the performance of the multilayer protective film and methods of forming the same.

### BACKGROUND

Multilayer protective films are generally designed for application and protection of a particular surface. However, after application of the protective film to the surface, imperfections can appear in the protective film due to delamination, diminishing the overall appearance of the covered surface. Accordingly, multilayer protective films that show improved installation performance and improved final appearance after installation are desired.

### SUMMARY

According to a first aspect, a multilayer protective film may include a multilayer component and a release liner component underlying the multilayer component. The multilayer component may have a first PET layer overlying a second PET layer. The multilayer protective film may further have a thickness ratio MPF_{T}:RL_{T} of not greater than about 14:1, where MPF_{T} is equal to the thickness of the multilayer component and RL_{T} is equal to the thickness of the release liner component.

According to another aspect, a multilayer protective film may include a multilayer component and a release liner component underlying the multilayer component. The multilayer component may have a first PET layer overlying a second PET layer. The multilayer protective film may further have a thickness ratio PET-1_{T}:RL_{T} of not greater than about 4:1, where PET-1_{T} is equal to the average thickness of the first PET layer of the multilayer component and RL_{T} is equal to the average thickness of the release liner component.

According to still another aspect, a multilayer protective film may include a multilayer component and a release liner component underlying the multilayer component. The multilayer component may have a first PET layer overlying a second PET layer. The release liner component may have a thickness of at least about 35 microns.

According to yet another aspect, a multilayer protective film may include a multilayer component and a release liner component underlying the multilayer component. The multilayer component may have a first PET layer overlying a second PET layer. The multilayer protective film may further have an edge delamination time rating of at least about 10 hrs.

According to another aspect, a multilayer protective film may include a multilayer component and a release liner component underlying the multilayer component. The multilayer component may have a first PET layer overlying a second PET layer. The multilayer protective film may further have an edge delamination thickness rating of not greater than about 1.6 mm.

According to still another aspect, a multilayer protective film may include a multilayer component and a release liner component underlying the multilayer component. The multilayer component may have a first PET layer overlying a second PET layer. The multilayer protective film may further have an installed optical distortion within 1 inch of an outer edge of the multilayer protective film of not greater than twice the optical distortion at the center of the multilayer protective film as measured according to ASTM C1651-11.

According to another aspect, a method of forming a multilayer protective film may include providing a multilayer component and applying a release liner component to the multilayer component. The multilayer component may have a first PET layer overlying a second PET layer. The multilayer protective film may further have a thickness ratio MPF_{T}:RL_{T} of not greater than about 14:1, where MPF_{T} is equal to the thickness of the multilayer component and RL_{T} is equal to the thickness of the release liner component.

According to another aspect, a method of forming a multilayer protective film may include providing a multilayer component and applying a release liner component to the multilayer component. The multilayer component may have a first PET layer overlying a second PET layer. The multilayer protective film may further have a thickness ratio PET-1_{T}:RL_{T} of not greater than about 4:1, where PET-1_{T} is equal to the average thickness of the first PET layer of the multilayer component and RL_{T} is equal to the average thickness of the release liner component.

According to still another aspect, a method of forming a multilayer protective film may include providing a multilayer component and applying a release liner component to the multilayer component. The multilayer component may have a first PET layer overlying a second PET layer. The release liner component may have a thickness of at least about 35 microns.

According to yet another aspect, a method of forming a multilayer protective film may include providing a multilayer component and applying a release liner component to the multilayer component. The multilayer component may have a first PET layer overlying a second PET layer. The multilayer protective film may further have an edge delamination time rating of at least about 10 hrs.

According to another aspect, a method of forming a multilayer protective film may include providing a multilayer component and applying a release liner component to the multilayer component. The multilayer component may have a first PET layer overlying a second PET layer. The multilayer protective film may further have an edge delamination thickness rating of not greater than about 1.6 mm.

According to still another aspect, a method of forming a multilayer protective film may include providing a multilayer component and applying a release liner component to the multilayer component. The multilayer component may have a first PET layer overlying a second PET layer. The multilayer protective film may further have an installed optical distortion within 1 inch of an outer edge of the multilayer protective film of not greater than twice the optical distortion at the center of the multilayer protective film as measured according to ASTM C1651-11.

### BRIEF DESCRIPTION OF THE DRAWINGS

Embodiments are illustrated by way of example and are not limited to the accompanying figures.

FIG. 1 includes an illustration of a multilayer protective film according to embodiments described herein;

FIG. 2 includes an illustration of a multilayer protective film according to embodiments described herein;

FIG. 3 includes an illustration of a multilayer protective film according to embodiments described herein;

FIG. 4 includes an illustration of a multilayer protective film according to embodiments described herein;

FIG. 5 includes a diagram showing a multilayer protective film forming method 500 according to embodiments described herein; and

FIG. 6 includes a diagram showing a multilayer protective film forming method 600 according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayer protective film that includes a multilayer component and a release liner component underlying the multilayer component. The release liner component may have a particular thickness relative to the thickness of the multilayer protective film. The combination of the multilayer component and the release liner component having such a particular thickness may provide improved performance of the multilayer protective film.

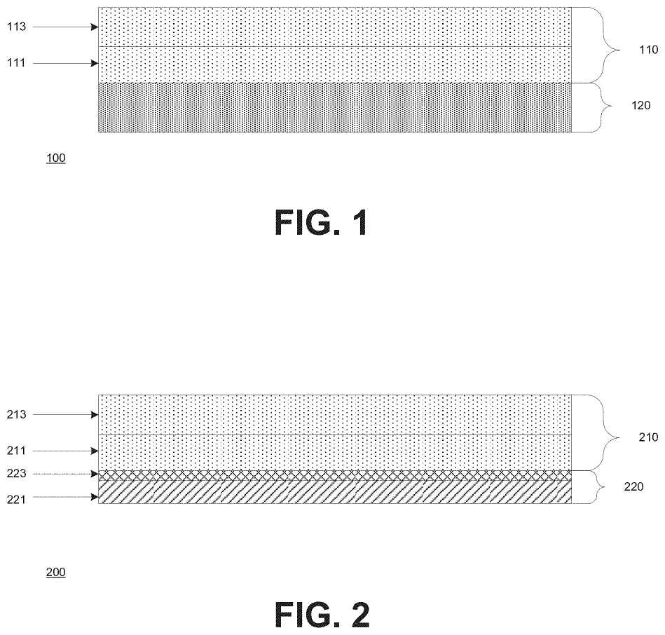

For purposes of illustration, FIG. 1 includes an illustration of a multilayer protective film 100 according to embodiments described herein. A shown in FIG. 1, a multilayer protective film 100 may include a multilayer component 110 and a release liner component 120. According to particular embodiments, and as further shown in FIG. 1, the multilayer component 110 may include a first polyethylene terephthalate (PET) layer 111 and a second PET layer 113. According to certain embodiments the first PET layer 111 may overly the second PET layer 113.

According to certain embodiments, the multilayer protective film 100 may have a particular thickness ratio MPF_{T}:RL_{T}, where MPF_{T} is equal to the thickness of the multilayer component 110 and RL_{T} is equal to the thickness of the release liner component 120. For example, the multilayer protective film 100 may have a thickness ratio MPF_{T}:RL_{T} of not greater than about 14:1, such as, not greater than about 13:1 or not greater than about 12:1 or not greater than about 11:1 or not greater than about 10:1 or not greater than about 9:1 or not greater than about 8:1 or not greater than about 7:1 or not greater than about 6:1 or not greater than about 5:1 or not greater than about 4:1 or not greater than about 3:1 or not greater than about 2:1 or even not greater than about 1:1. According to still other embodiments, the multilayer protective film 100 may have a thickness ratio MPF_{T}:RL_{T} of at least about 1:7, such as, at least about 1:6 or at least about 1:5 or at least about 1:4 or at least about 1:3 or even at least about 1:2. It will be appreciated that the thickness ratio MPF_{T}:RL_{T} of the multilayer protective film 100 may be within a range between any of the minimum and maximum values noted above. It will be further appreciated that the thickness ratio MPF_{T}:RL_{T} of the multilayer protective film 100 may be any value between any of the minimum and maximum values noted above.

According to yet other embodiments, the multilayer protective film 100 may have a particular thickness ratio PET-1_{T}:RL_{T}, where PET-1_{T} is equal to the average thickness of the first PET layer 111 (i.e., the PET layer closest to the release liner component 120) of the multilayer component 100 and RL_{T} is equal to the average thickness of the release liner component 120. For example, the multilayer protective film 100 may have a thickness ratio PET-1_{T}:RL_{T} of not greater than about 4:1, such as, not greater than about 3.5:1 or not greater than about 3:1 or not greater than about 2.5:1 or not greater than about 2:1 or not greater than about 1.5:1 or even not greater than about 1:1. According to still other embodiments, the multilayer protective film 100 may have a thickness ratio PET-1_{T}:RL_{T} of at least about 1:10, such as, at least about 1:9 or at least about 1:8 or at least about 1:7 at least about 1:6 or at least about 1:5 or at least about 1:4 or at least about 1:3 or even at least about 1:2. It will be appreciated that the thickness ratio PET-1_{T}:RL_{T} of the multilayer protective film 100 may be within a range between any of the minimum and maximum values noted above. It will be further appreciated that the thickness ratio PET-1_{T}:RL_{T} of the multilayer protective film 100 may be any value between any of the minimum and maximum values noted above.

According to yet other embodiments, the multilayer protective film 100 may have a particular thickness ratio PET-2_{T}:RL_{T}, where PET-2_{T} is equal to the average thickness of the second PET layer 113 (i.e., the PET layer overlying and closest to the first PET layer) of the multilayer component 100 and RL_{T} is equal to the average thickness of the release liner component 120. For example, the multilayer protective film 100 may have a thickness ratio PET-2_{T}:RL_{T} of not greater than about 4:1, such as, not greater than about 3.5:1 or not greater than about 3:1 or not greater than about 2.5:1 or not greater than about 2:1 or not greater than about 1.5:1 or even not greater than about 1:1. According to still other embodiments, the multilayer protective film 100 may have a thickness ratio PET-2_{T}:RL_{T} of at least about 1:10, such as, at least about 1:9 or at least about 1:8 or at least about 1:7 at least about 1:6 or at least about 1:5 or at least about 1:4 or at least about 1:3 or even at least about 1:2. It will be appreciated that the thickness ratio PET-2_{T}:RL_{T} of the multilayer protective film 100 may be within a range between any of the minimum and maximum values noted above. It will be further appreciated that the thickness ratio PET-2_{T}:RL_{T} of the multilayer protective film 100 may be any value between any of the minimum and maximum values noted above.

According to yet other embodiments, the release liner component 120 may have a particular thickness (i.e., RL_{T}). For example, the release liner component 120 may have a thickness of at least about 35 microns, such as, at least about 40 microns or at least about 50 microns or at least about 60 microns or at least about 70 microns or at least about 80 microns or at least about 90 microns or at least about 100 microns or at least about 110 microns or at least about 120 microns or at least about 130 microns or at least about 140 microns or even at least about 150 microns. According to still other embodiments, the release liner component 120 may have a thickness or not greater than about 300 microns, such as, not greater than about 290 microns or not greater than about 280 microns or not greater than about 270 microns or not greater than about 260 microns or not greater than about 250 microns or not greater than about 240 microns or not greater than about 230 microns or not greater than about 220 microns or not greater than about 210 microns or even not greater than about 200 microns. It will be appreciated that the thickness of the release liner component 120 may be within a range between any of the minimum and maximum values noted above. It will be further appreciated that the thickness of the release liner component 120 may be any value between any of the minimum and maximum values noted above.

According to yet other embodiments, the multilayer component 110 may have a particular thickness (i.e., MPF_{T}). For example, the multilayer component 110 may have a thickness of at least about 5 microns, such as, at least about 25 microns or at least about 50 microns or at least about 75 microns or at least about 100 microns or at least about 125 microns or at least about 150 microns or at least about 175 microns or at least about 200 microns or at least about 225 microns or at least about 250 microns or at least about 275 microns or even at least about 300 microns or even at least about 325 microns or even at least about 350 microns or even at least about 375 microns or even at least about 400 microns or even at least about 425 microns or even at least about 450 or even at least about 475 microns. According to still other embodiments, the multilayer component 110 may have a thickness or not greater than about 2000 microns, such as, not greater than about 1900 microns or not greater than about 1800 microns or not greater than about 1700 microns or not greater than about 1600 microns or not greater than about 1500 microns or not greater than about 1250 microns or not greater than about 1000 microns or not greater than about 750 microns or even not greater than about 500 microns. It will be appreciated that the thickness of the multilayer component 110 may be within a range between any of the minimum and maximum values noted above. It will be further appreciated that the thickness of the multilayer component 110 may be any value between any of the minimum and maximum values noted above.

According to yet other embodiments, the first PET layer 111 may have a particular thickness (i.e., PET-1_{T}). For example, the first PET layer 111 may have a thickness of at least about 5 microns, such as, at least about 10 microns or at least about 15 microns or at least about 20 microns or at least about 25 microns or at least about 30 microns or at least about 35 microns or at least about 40 microns or at least about 50 microns or at least about 60 microns or at least about 70 microns or at least about 80 microns or at least about 90 microns or at least about 100 microns or at least about 110 microns or at least about 120 microns or at least about 130 microns or at least about 140 microns or even at least about 150 microns. According to still other embodiments, the first PET layer 111 may have a thickness of not greater than about 400 microns, such as, not greater than about 390 microns or not greater than about 380 microns or not greater than about 370 microns or not greater than about 360 microns or not greater than about 350 microns or not greater than about 340 microns or not greater than about 330 microns or not greater than about 320 microns or not greater than about 310 microns or not greater than about 300 microns or not greater than about 290 microns or not greater than about 280 microns or not greater than about 270 microns or not greater than about 260 microns or not greater than about 250 microns or not greater than about 240 microns or not greater than about 230 microns or not greater than about 220 microns or not greater than about 210 microns or even not greater than about 200 microns. It will be appreciated that the thickness of the first PET layer 111 may be within a range between any of the minimum and maximum values noted above. It will be further appreciated that the thickness of the first PET layer 111 may be any value between any of the minimum and maximum values noted above.

According to yet other embodiments, the second PET layer 113 may have a particular thickness (i.e., PET-2_{T}). For example, the second PET layer 113 may have a thickness of at least about 5 microns, such as, at least about 10 microns or at least about 15 microns or at least about 20 microns or at least about 25 microns or at least about 30 microns or at least about 35 microns or at least about 40 microns or at least about 50 microns or at least about 60 microns or at least about 70 microns or at least about 80 microns or at least about 90 microns or at least about 100 microns or at least about 110 microns or at least about 120 microns or at least about 130 microns or at least about 140 microns or even at least about 150 microns. According to still other embodiments, the second PET layer 113 may have a thickness or not greater than about 400 microns, such as, not greater than about 390 microns or not greater than about 380 microns or not greater than about 370 microns or not greater than about 360 microns or not greater than about 350 microns or not greater than about 340 microns or not greater than about 330 microns or not greater than about 320 microns or not greater than about 310 microns or not greater than about 300 microns or not greater than about 290 microns or not greater than about 280 microns or not greater than about 270 microns or not greater than about 260 microns or not greater than about 250 microns or not greater than about 240 microns or not greater than about 230 microns or not greater than about 220 microns or not greater than about 210 microns or even not greater than about 200 microns. It will be appreciated that the thickness of the second PET layer 113 may be within a range between any of the minimum and maximum values noted above. It will be further appreciated that the thickness of the second PET layer 113 may be any value between any of the minimum and maximum values noted above.

According to still other embodiments, the multilayer component 110 of the multilayer protective film 100 may have a particular number of PET layers (i.e., a particular number of PET layers including, and in addition to, the first PET layer 111 and the second PET layer 113). For example, the multilayer component 110 may include at least about 3 PET layers, such as, at least about 4 PET layers or even at least about 5 PET layers or at least about 6 PET layers or at least about 7 PET layers or at least about 8 PET layers or at least about 9 PET layers or at least about 10 PET layers or at least about 11 PET layers or at least about 12 PET layers or at least about 13 PET layers or at least about 14 PET layers or even at least about 15 PET layers. According to still other embodiments, the multilayer component 110 may include not greater than about 20 PET layers, such as, not greater than about 19 PET layers. It will be appreciated that the number of PET layers in the multilayer component 110 may be within a range between any of the minimum and maximum values noted above. It will be further appreciated that the number of PET layers in the multilayer component 110 may be any value between any of the minimum and maximum values noted above.

According to yet other embodiments, the multilayer protective film 100 may have a particular edge delamination time rating (EDTR), where the EDTR of a particular multilayer protective film is defined as the number of hours that the multilayer protective film can go without delamination after it cut, either with a laser or mechanically, and then wet-laminated to a glass substrate. For purposes of evaluating the EDTR of a particular multilayer protective film, delamination is defined as haze/clouding appearing at a point greater than 1.5 mm from the edge of the multilayer protective film. For example, the multilayer protective film 100 may have an EDTR of at least about 10 hours, such as, at least about 11 hours or at least about 12 hours or at least about 13 hours or at least about 14 hours or at least about 15 hours or at least about 16 hours or at least about 17 hours or at least about 18 hours or at least about 19 hours or at least about 20 hours or at least about 21 hours or at least about 22 hours or at least about 23 hours or even at least about 24 hours. It will be appreciated that the EDTR of the multilayer protective film 100 may be within a range between any of the values noted above. It will be further appreciated that the EDTR of the multilayer protective film 100 may be any value between any of the values noted above.

According to still other embodiments, the multilayer protective film 100 may have a particular edge delamination thickness rating (EDTHR), where the EDTHR of a particular multilayer protective film is defined as the distance from any edge of the multilayer protective film with no signs of delamination 24 hours after the multilayer protective film is cut, either with a laser or mechanically, and then wet-laminated to a glass substrate. For purposes of evaluating the EDTHR of a particular multilayer protective film, delamination is defined as a haze/clouding of the film. For example, the multilayer protective film 100 may have an EDTHR of not greater than about 1.6 mm, such as, not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or even not greater than about 0.1 mm. It will be appreciated that the EDTHR of the multilayer protective film 100 may be within a range between any of the values noted above. It will be further appreciated that the EDTHR of the multilayer protective film 100 may be any value between any of the values noted above.

According to yet other embodiments, the multilayer protective film 100 may have a particular edge optical distortion ratio EOD:COD, where EOD is equal to the optical distortion of the multilayer protective film 100 measured within 1 inch of an outer edge of the multilayer protective film 100 and COD is equal to the optical distortion of the multilayer protective film 100 measured at the center of the multilayer protective film. For purposes of embodiments described herein, optical distortion may be measure according to ASTM C1651-11. For example, the multilayer protective film 100 may have an edge optical distortion ratio EOD:COD of not greater than about 2:1, such as, not greater than about 1.9:1 or not greater than about 1.8:1 or not greater than about 1.7:1 or not greater than about 1.6:1 or not greater than about 1.5:1 or not greater than about 1.4:1 or not greater than about 1.3:1 or not greater than about 1.2:1 or even not greater than about 1.1:1. It will be appreciated that the edge optical distortion ratio EOD:COD of the multilayer protective film 100 may be within a range between any of the values noted above. It will be further appreciated that the edge optical distortion ratio EOD:COD of the multilayer protective film 100 may be any value between any of the values noted above.

According to still other embodiments, the multilayer protective film 200 may have particular adhesion strength between the multilayer component 110 and the release liner 120 as measure in a 180 degree peel. For example, the adhesion strength between the multilayer component 110 and the release liner 120 may be at least about 1 gram per inch, such as, at least about at least about 2 grams per inch or at least about 3 grams per inch or at least about 4 grams per inch or at least about 5 grams per inch or at least about 6 grams per inch or at least about 7 grams per inch or at least about 8 grams per inch or at least about 9 grams per inch or at least about 10 grams per inch or at least about 11 grams per inch or at least about 12 grams per inch or at least about 13 grams per inch or at least about 14 grams per inch or even at least about 15 grams per inch. According to still other embodiments, the adhesion strength between the multilayer component 110 and the release liner 120 may be not greater than about 45 grams per inch, such as, not greater than about 44 grams per inch or not greater than about 43 grams per inch or not greater than about 42 grams per inch or not greater than about 41 grams per inch or not greater than about 40 grams per inch or not greater than about 39 grams per inch or not greater than about 38 grams per inch or not greater than about 37 grams per inch or not greater than about 36 grams per inch or not greater than about 35 grams per inch or not greater than about 34 grams per inch or not greater than about 33 grams per inch or not greater than about 32 grams per inch or not greater than about 31 grams per inch or not greater than about 30 grams per inch or not greater than about 29 grams per inch or not greater than about 28 grams per inch or not greater than about 27 grams per inch or not greater than about 26 grams per inch or not greater than about 25 grams per inch or not greater than about 24 grams per inch or not greater than about 23 grams per inch or not greater than about 22 grams per inch or not greater than about 21 grams per inch or not greater than about 20 grams per inch or not greater than about 19 grams per inch or not greater than about 18 grams per inch or not greater than about 17 grams per inch or even not greater than about 16 grams per inch. It will be appreciated that the adhesion strength between the multilayer component 110 and the release liner 120 may be within a range between any of the values noted above. It will be further appreciated that adhesion strength between the multilayer component 110 and the release liner 120 may be any value between any of the values noted above.

Referring specifically to the release liner component, according to embodiments described herein, the release liner component may include a substrate component, a release coating component attached to the substrate component and an adhesive component between the release coating component and the multilayer component.

For purposes of further illustration, FIG. 2 includes an illustration of a multilayer protective film 200 according to additional embodiments described herein. As shown in FIG. 2, a multilayer protective film 200 may include a multilayer component 210 and a release liner component 220. According to particular embodiments, and as further shown in FIG. 2, the multilayer component 210 may include a first PET layer 211 and a second PET layer 213. According to certain embodiments the first PET layer 211 may overly the second PET layer 213. According to yet other embodiments, and as further shown in FIG. 2, the release liner component 220 may include a substrate component 221 and a release coating component 223 attached to the substrate component between the substrate component 221 and the multilayer component 210.

It will be appreciated that the multilayer protective film 200 and all components described in reference to the multilayer protective film 200 as shown in FIG. 2 may have any of the characteristics described herein with reference to corresponding components in FIG. 1. In particular, the characteristics of the multilayer protective film 200, the multilayer component 210, the release liner 220, the first PET layer 211 and the second PET layer 213 shown in FIG. 2 may have any of the corresponding characteristics described herein in reference to the multilayer protective film 100, the multilayer component 110, the release liner 120, the first PET layer 111 and the second PET layer 113 shown in FIG. 1, respectively.

Referring specifically to the release liner component 220, according to certain embodiments, the substrate component 221 may include particular materials. For example, the substrate component 221 may include PET, polycarbonate, polyethylene variations, HDPE, LDPE, paper, fluoropolymer, ETFE, FEP or combinations thereof. According to still other embodiments, the substrate component 221 may consist essentially of particular materials. For example, the substrate component 221 may consist essentially of PET, polycarbonate, polyethylene variations, HDPE, LDPE, paper, fluoropolymer, ETFE, FEP or combinations thereof.

According to still other embodiments, the substrate component 221 of the release liner component 220 may have a particular thickness. For example the substrate component 221 may have a thickness of at least about 25 microns, such as, at least about 35 microns or at least about 40 microns or at least about 50 microns or at least about 60 microns or at least about 70 microns or at least about 80 microns or at least about 90 microns or at least about 100 microns or at least about 110 microns or at least about 120 microns or at least about 130 microns or at least about 140 microns or even at least about 150 microns. According to still other embodiments, the release liner component 120 may have a thickness or not greater than about 300 microns, such as, not greater than about 290 microns or not greater than about 280 microns or not greater than about 270 microns or not greater than about 260 microns or not greater than about 250 microns or not greater than about 240 microns or not greater than about 230 microns or not greater than about 220 microns or not greater than about 210 microns or even not greater than about 200 microns. It will be appreciated that the thickness of the substrate component 221 may be within a range between any of the minimum and maximum values noted above. It will be further appreciated that the thickness of the substrate component 221 may be any value between any of the minimum and maximum values noted above.

According to still other embodiments, the release coating component 223 may include particular materials. For example, the release coating component 223 may include a silicone-based coating material, a fluoro-based coating material, an acrylic-based coating material, an acrylic-based coating material, a polyurethane-based coating material or combinations thereof. According to still other embodiments, the release coating component 223 may consist essentially of particular materials. For example, the release coating component 223 may consist essentially of a silicone-based coating material, a fluoro-based coating material, an acrylic-based coating material, an acrylic-based coating material, a polyurethane-based coating material or combinations thereof.

According to still other embodiments, the release coating component 223 of the release liner component 220 may have a particular thickness. For example the release coating component 223 may have a thickness of at least about 0.01 microns, such as, at least about 0.05 microns or at least about 0.1 microns or at least about 0.15 microns or at least about 0.2 microns or at least about 0.25 microns or at least about 0.3 microns or at least about 0.35 microns or at least about 0.4 microns or at least about 0.45 microns or at least about 0.5 microns or at least about 0.6 microns or at least about 0.7 microns or at least about 0.8 microns or at least about 0.9 microns or even at least about 1.0 micron. According to yet other embodiments, the release coating component 223 may have a thickness of not greater than about 10 microns, such as, not greater than about 9 microns or not greater than about 8 microns or not greater than about 7 microns or not greater than about 6 microns or not greater than about 5 microns or not greater than about 4 microns or even not greater than about 3 microns. It will be appreciated that the thickness of the release coating component 223 may be within a range between any of the minimum and maximum values noted above. It will be further appreciated that the thickness of the release coating component 223 may be any value between any of the minimum and maximum values noted above.

Referring further to a protective film according to embodiments described herein, the protective film may include a substrate component, a release coating component and an adhesive component between the substrate component and the release coating component.

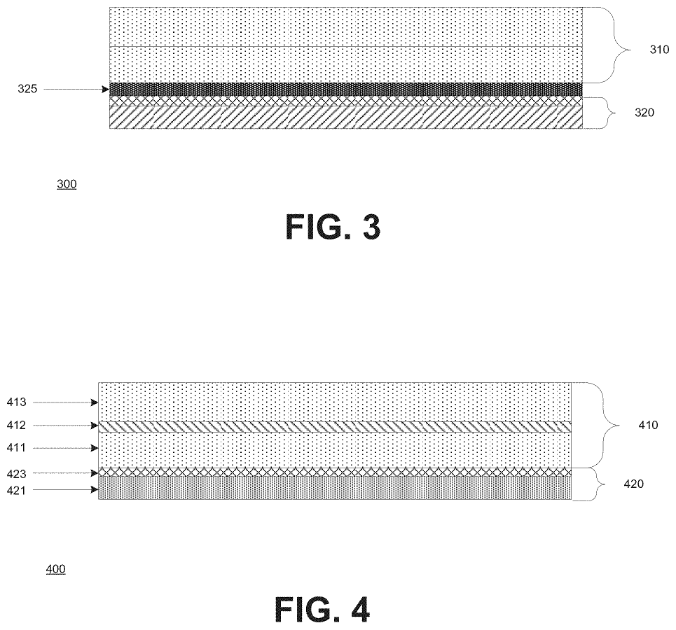

For purposes of further illustration, FIG. 3 includes an illustration of a multilayer protective film 300 according to additional embodiments described herein. As shown in FIG. 3, a multilayer protective film 300 may include a multilayer component 310, a release liner component 320, and an adhesive component 325 between the release liner component 320 and the multilayer component 310.

It will be appreciated that the multilayer protective film 300 and all components described in reference to the multilayer protective film 300 as shown in FIG. 3 may have any of the characteristics described herein with reference to corresponding components in FIG. 1 and/or FIG. 2. In particular, the characteristics of the multilayer protective film 300, the multilayer component 310, and the release liner 320 shown in FIG. 3 may have any of the corresponding characteristics described herein in reference to the multilayer protective film 200 (100), the multilayer component 210 (110), the release liner 220 (120), the first PET layer 211 (111) and the second PET layer 213 (113) shown in FIG. 1 and/or FIG. 2, respectively.

According to still other embodiments, the adhesive component 325 may include particular materials. For example, the adhesive component 325 may include an acrylic-based adhesive, a silicone-based adhesive, a semi-permanent pressure sensitive adhesive, and combinations thereof. According to still other embodiments, the adhesive component 325 may consist essentially of particular materials. For example, the adhesive component 325 may consist essentially of an acrylic-based adhesive, a silicone-based adhesive, a semi-permanent pressure sensitive adhesive, and combinations thereof.

According to still other embodiments, the adhesive component 325 may have a particular thickness. For example the adhesive component 325 may have a thickness of at least about 3 microns, such as, at least about 4 microns or at least about 5 microns or at least about 6 microns or at least about 7 microns or at least about 8 microns or at least about 9 microns or at least about 10 microns or at least about 11 microns or at least about 12 microns or even at least about 13 microns. According to yet other embodiments, the adhesive component 325 may have a thickness of not greater than about 30 microns, such as, not greater than about 29 microns or not greater than about 28 microns or not greater than about 27 microns or not greater than about 26 microns or not greater than about 25 microns or not greater than about 24 microns or not greater than about 23 microns or not greater than about 22 microns or not greater than about 21 microns or not greater than about 20 microns or not greater than about 19 microns or not greater than about 18 microns or not greater than about 17 microns or not greater than about 16 microns or even not greater than about 15 microns. It will be appreciated that the thickness of the adhesive component 325 may be within a range between any of the minimum and maximum values noted above. It will be further appreciated that the thickness of the adhesive component 325 may be any value between any of the minimum and maximum values noted above.

Referring further to the multilayer component, according to other embodiments described herein, the multilayer component may include an adhesive layer between the first PET layer and the second PET layer.

For purposes of further illustration, FIG. 4 includes an illustration of a multilayer protective film 400 according to additional embodiments described herein. A shown in FIG. 4, a multilayer protective film 400 may include a multilayer component 410 and a release liner component 420. According to particular embodiments, and as further shown in FIG. 4, the multilayer component 410 may include a first PET layer 411, a second PET layer 413 and a first multilayer component adhesive layer 412. According to certain embodiments the first PET layer 411 may overly the second PET layer 413, and the first multilayer component adhesive layer 412 may be in between the first PET layer 411 and the second PET layer 413. According to yet other embodiments, and as further shown in FIG. 4, the release liner component 420 may include a substrate component 421, and a release coating component 423 attached to the substrate component 421.

It will be appreciated that the multilayer protective film 400 and all components described in reference to the multilayer protective film 400 as shown in FIG. 4 may have any of the characteristics described herein with reference to corresponding components in FIG. 1, FIG. 2 and/or FIG. 3. In particular, the characteristics of the multilayer protective film 400, the multilayer component 410, the release liner 420, the first PET layer 411, the second PET layer 413, the substrate component 421, and the release coating component 423 shown in FIG. 4 may have any of the corresponding characteristics described herein in reference to the multilayer protective film 100 (200, 300), the multilayer component 110 (210, 310), the release liner 120 (220, 320), the first PET layer 111 (211, 311), the second PET layer 113 (213, 313), the substrate component 221, and the release coating component 223 shown in FIG. 1, FIG. 2 and/or FIG. 3, respectively.

Referring specifically to the first multilayer component adhesive layer 412 of the multilayer component 410, the first multilayer component adhesive layer 412 may include a particular material. For example, the first multilayer component adhesive layer 412 may include a non-permanent adhesive, an acrylic-based adhesive, and a silicone-based adhesive, a semi-permanent pressure sensitive adhesive, and combinations thereof. According to still other embodiments, the first multilayer component adhesive layer 412 may consist essentially of a particular material. For example, the first multilayer component adhesive layer 412 may consist essentially of a non-permanent adhesive, an acrylic-based adhesive, and a silicone-based adhesive, a semi-permanent pressure sensitive adhesive, and combinations thereof.

According to yet other embodiments, the first multilayer component adhesive layer 412 of the multilayer component 410 may have a particular thickness. For example, the first multilayer component adhesive layer 412 may have a thickness of at least about 3 microns, such as, at least about 4 microns or at least about 5 microns or at least about 6 microns or at least about 7 microns or at least about 8 microns or at least about 9 microns or at least about 10 microns or at least about 11 microns or at least about 12 microns or even at least about 13 microns. According to yet other embodiments, the first multilayer component adhesive layer 412 may have a thickness of not greater than about 30 microns, such as, not greater than about 29 microns or not greater than about 28 microns or not greater than about 27 microns or not greater than about 26 microns or not greater than about 25 microns or not greater than about 24 microns or not greater than about 23 microns or not greater than about 22 microns or not greater than about 21 microns or not greater than about 20 microns or not greater than about 19 microns or not greater than about 18 microns or not greater than about 17 microns or not greater than about 16 microns or even not greater than about 15 microns. It will be appreciated that the thickness of the first multilayer component adhesive layer 412 may be within a range between any of the minimum and maximum values noted above. It will be further appreciated that the thickness of the first multilayer component adhesive layer 412 may be any value between any of the minimum and maximum values noted above.

According to still other embodiments, the multilayer component may include at least one multilayer component adhesive layer between each pair of PET layers.

According to still other embodiments, each multilayer component adhesive layer in the multilayer component may include a particular material. For example, each multilayer component adhesive layer in the multilayer component may include a non-permanent adhesive, an acrylic-based adhesive, and a silicone-based adhesive, a semi-permanent pressure sensitive adhesive, and combinations thereof. According to still other embodiments, each multilayer component adhesive layer in the multilayer component may consist essentially of a particular material. For example, each multilayer component adhesive layer in the multilayer component may consist essentially of a non-permanent adhesive, an acrylic-based adhesive, and a silicone-based adhesive, a semi-permanent pressure sensitive adhesive, and combinations thereof.

According to yet other embodiments, each multilayer component adhesive layer in the multilayer component may have a particular thickness. For example, each multilayer component adhesive layer in the multilayer component may have a thickness of at least about 3 microns, such as, at least about 4 microns or at least about 5 microns or at least about 6 microns or at least about 7 microns or at least about 8 microns or at least about 9 microns or at least about 10 microns or at least about 11 microns or at least about 12 microns or even at least about 13 microns. According to yet other embodiments, each multilayer component adhesive layer in the multilayer component may have a thickness of not greater than about 30 microns, such as, not greater than about 29 microns or not greater than about 28 microns or not greater than about 27 microns or not greater than about 26 microns or not greater than about 25 microns or not greater than about 24 microns or not greater than about 23 microns or not greater than about 22 microns or not greater than about 21 microns or not greater than about 20 microns or not greater than about 19 microns or not greater than about 18 microns or not greater than about 17 microns or not greater than about 16 microns or even not greater than about 15 microns. It will be appreciated that the thickness of each multilayer component adhesive layer in the multilayer component may be within a range between any of the minimum and maximum values noted above. It will be further appreciated that each multilayer component adhesive layer in the multilayer component may be any value between any of the minimum and maximum values noted above.

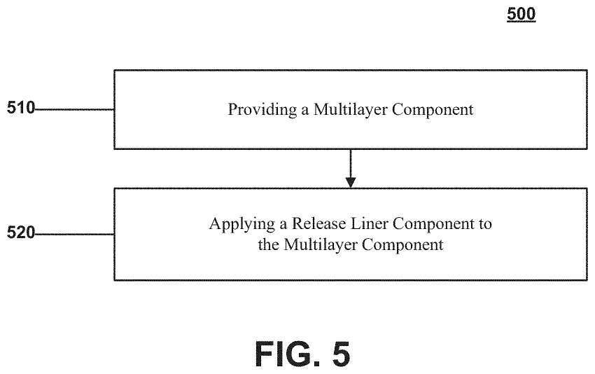

Turning now to methods of forming a multilayer protective film according to embodiments described herein, FIG. 5 includes a diagram, for purposes of illustration, showing a multilayer protective film forming method 500 according to particular embodiments described herein. The multilayer protective film forming method 500 may include a first step 510 of providing a multilayer component and a second step 520 of applying a release liner component to the multilayer component.

It will be appreciated that the multilayer protective film and all components referenced in regards to the multilayer protective film forming method 500 as shown in FIG. 5 may have any of the characteristics described herein with reference to the multilayer protective films and any components of the multilayer protective films shown in or described in reference to FIG. 1, FIG. 2, FIG. 3 and/or FIG. 4.

Turning now to still other embodiments, a multilayer protective film according to embodiments described herein may be a pre-cut multilayer protective window film.

It will be appreciated that a pre-cut multilayer protective window film according to embodiment described herein may have any of the characteristics described herein with reference to the multilayer protective films and any components of the multilayer protective films shown in or described in reference to FIG. 1, FIG. 2, FIG. 3 and/or FIG. 4.

According to particular embodiments described herein, the pre-cut multilayer protective window film may have a particular pre-cut length. For example, the pre-cut length of the pre-cut multilayer protective window film may be at least about 100 mm, such as, at least about 150 mm or at least about 200 mm or at least about 250 mm or at least about 300 mm or at least about 350 mm or at least about 400 mm or at least about 450 mm or at least about 500 mm or at least about 550 mm or at least about 600 mm or at least about 650 mm or at least about 700 mm or at least about 750 mm or at least about 800 mm or at least about 850 mm or at least about 900 mm or at least about 950 mm or even at least about 1000 mm. According to yet other embodiments, the pre-cut length of the pre-cut multilayer protective window film may be not greater than about 3500 mm, such as, not greater than about 3450 mm or not greater than about 3400 mm or not greater than about 3350 mm or not greater than about 3300 mm or not greater than about 3250 mm or not greater than about 3200 mm or not greater than about 3150 mm or not greater than about 3100 mm or not greater than about 3050 mm or not greater than about 3000 mm or not greater than about 2950 mm or not greater than about 2900 mm or not greater than about 2850 mm or not greater than about 2800 mm or not greater than about 2750 mm or not greater than about 2700 mm or not greater than about 2650 mm or not greater than about 2600 mm or not greater than about 2550 mm or not greater than about 2500 mm or not greater than about 2450 mm or not greater than about 2400 mm or not greater than about 2350 mm or not greater than about 2300 mm or not greater than about 2250 mm or not greater than about 2200 mm or not greater than about 2150 mm or not greater than about 2100 mm or not greater than about 2050 mm or even not greater than about 2000 mm. It will be appreciated the pre-cut length of the pre-cut multilayer protective window film may be within a range between any of the minimum and maximum values noted above. It will be further appreciated that the pre-cut length of the pre-cut multilayer protective window film may be any value between any of the minimum and maximum values noted above.

According to particular embodiments described herein, the pre-cut multilayer protective window film may have a particular pre-cut width. For example, the pre-cut width of the pre-cut multilayer protective window film may be at least about 100 mm, such as, at least about 150 mm or at least about 200 mm or at least about 250 mm or at least about 300 mm or at least about 350 mm or at least about 400 mm or at least about 450 mm or at least about 500 mm or at least about 550 mm or at least about 600 mm or at least about 650 mm or at least about 700 mm or at least about 750 mm or at least about 800 mm or at least about 850 mm or at least about 900 mm or at least about 950 mm or even at least about 1000 mm. According to yet other embodiments, the pre-cut width of the pre-cut multilayer protective window film may be not greater than about 3500 mm, such as, not greater than about 3450 mm or not greater than about 3400 mm or not greater than about 3350 mm or not greater than about 3300 mm or not greater than about 3250 mm or not greater than about 3200 mm or not greater than about 3150 mm or not greater than about 3100 mm or not greater than about 3050 mm or not greater than about 3000 mm or not greater than about 2950 mm or not greater than about 2900 mm or not greater than about 2850 mm or not greater than about 2800 mm or not greater than about 2750 mm or not greater than about 2700 mm or not greater than about 2650 mm or not greater than about 2600 mm or not greater than about 2550 mm or not greater than about 2500 mm or not greater than about 2450 mm or not greater than about 2400 mm or not greater than about 2350 mm or not greater than about 2300 mm or not greater than about 2250 mm or not greater than about 2200 mm or not greater than about 2150 mm or not greater than about 2100 mm or not greater than about 2050 mm or even not greater than about 2000 mm. It will be appreciated the pre-cut width of the pre-cut multilayer protective window film may be within a range between any of the minimum and maximum values noted above. It will be further appreciated that the pre-cut width of the pre-cut multilayer protective window film may be any value between any of the minimum and maximum values noted above.

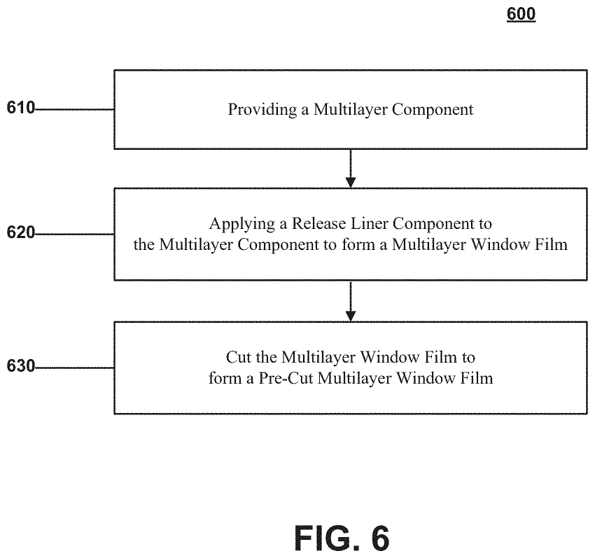

Turning now to methods of forming a pre-cut multilayer protective window film according to embodiments described herein, FIG. 6 includes a diagram, for purposes of illustration, showing a pre-cut multilayer protective window film forming method 600 according to particular embodiments described herein. The pre-cut multilayer protective window film forming method 600 may include a first step 610 of providing a multilayer component, a second step 620 of applying a release liner component to the multilayer component to form a multilayer protective window film, and a third step 630 of cutting the multilayer protective window film to form the pre-cut multilayer protective window film.

It will be appreciated that the pre-cut multilayer protective window film and all components referenced in regards to the pre-cut multilayer protective window film forming method 600 as shown in FIG. 6 may have any of the characteristics described herein with reference any components shown in FIG. 1, FIG. 2, FIG. 3, FIG. 4 and/or FIG. 5.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

A multilayer protective film comprising: a multilayer component comprising a first PET layer overlying a second PET layer; and a release liner component underlying the multilayer component, wherein the multilayer protective film has a thickness ratio MPF_{T}:RL_{T} of not greater than about 14:1, where MPF_{T} is equal to the thickness of the multilayer component and RL_{T} is equal to the thickness of the release liner component.

### Embodiment 2

A multilayer protective film comprising: a multilayer component comprising a first PET layer overlying a second PET layer; and a release liner component underlying the multilayer component, wherein the multilayer protective film has a thickness ratio PET-1_{T}:RL_{T} of not greater than about 4:1, where PET-1_{T} is equal to the average thickness of the first PET layer of the multilayer component and RL_{T} is equal to the average thickness of the release liner component.

### Embodiment 3

A multilayer protective film comprising: a multilayer component comprising a first PET layer overlying a second PET layer; and a release liner component underlying the multilayer component, wherein the release liner component has a thickness of at least about 35 microns.

### Embodiment 4

A multilayer protective film comprising: a multilayer component comprising a first PET layer overlying a second PET layer; and a release liner component underlying the multilayer component, wherein the multilayer protective film has an edge delamination time rating of at least about 10 hrs.

### Embodiment 5

A multilayer protective film comprising: a multilayer component comprising a first PET layer overlying a second PET layer; and a release liner component underlying the multilayer component, wherein the multilayer protective film has an edge delamination thickness rating of not greater than about 1.6 mm.

### Embodiment 6

A multilayer protective film comprising: a multilayer component comprising a first PET layer overlying a second PET layer; and a release liner component underlying the multilayer component, wherein the multilayer protective film has an edge optical distortion ratio EOD:COD of not greater than about 2:1, where EOD is equal to the optical distortion of the multilayer protective film measured within 1 inch of an outer edge of the multilayer protective film and COD is equal to the optical distortion of the multilayer protective film measured at the center of the multilayer protective film.

### Embodiment 7

A method of forming a multilayer protective film, wherein the method comprises: providing a multilayer component comprising a first PET layer overlying a second PET layer; and applying a release liner component to the multilayer component, wherein the multilayer protective film has a thickness ratio MPF_{T}:RL_{T} of not greater than about 14:1, where MPF_{T} is equal to the thickness of the multilayer component and RL_{T} is equal to the thickness of the release liner component.

### Embodiment 8

A method of forming a multilayer protective film, wherein the method comprises: providing a multilayer component comprising a first PET layer overlying a second PET layer; and applying a release liner component to the multilayer component, wherein the multilayer protective film has a thickness ratio PET-1_{T}:RL_{T} of not greater than about 4:1, where PET-1_{T} is equal to the average thickness of the first PET layer of the multilayer component and RL_{T} is equal to the average thickness of the release liner component.

### Embodiment 9

A method of forming a multilayer protective film, wherein the method comprises: providing a multilayer component comprising a first PET layer overlying a second PET layer; and applying a release liner component to the multilayer component, wherein the release liner component has a thickness of at least about 35 microns.

### Embodiment 10

A method of forming a multilayer protective film, wherein the method comprises: providing a multilayer component comprising a first PET layer overlying a second PET layer; and applying a release liner component to the multilayer component, wherein the multilayer protective film has an edge delamination time rating of at least about 10 hrs.

### Embodiment 11

A method of forming a multilayer protective film, wherein the method comprises: providing a multilayer component comprising a first PET layer overlying a second PET layer; and applying a release liner component to the multilayer component, wherein the multilayer protective film has an edge delamination thickness rating of not greater than about 1.6 mm.

### Embodiment 12

A method of forming a multilayer protective film, wherein the method comprises: providing a multilayer component comprising a first PET layer overlying a second PET layer; and applying a release liner component to the multilayer component, wherein the multilayer protective film has an edge optical distortion ratio EOD:COD of not greater than about 2:1, where EOD is equal to the optical distortion of the multilayer protective film measured within 1 inch of an outer edge of the multilayer protective film and COD is equal to the optical distortion of the multilayer protective film measured at the center of the multilayer protective film.

### Embodiment 13

The multilayer protective film or method of any one of embodiments 1, 2, 3, 4, 5, 6, 7, 8, 9, 10, 11, and 12, wherein the multilayer protective film has a thickness ratio MPF_{T}:RL_{T} of not greater than about 14:1, where MPF_{T} is equal to the average thickness of the multilayer component and RL_{T} is equal to the average thickness of the release liner component.

### Embodiment 14

The multilayer protective film or method of any one of embodiments 1, 2, 3, 4, 5, 6, 7, 8, 9, 10, 11, and 12, wherein the multilayer protective film has a thickness ratio MPF_{T}:RL_{T} of at least about 1:7, where MPF_{T} is equal to the average thickness of the multilayer component and RL_{T} is equal to the average thickness of the release liner component.

### Embodiment 15

The multilayer protective film or method of any one of embodiments 1, 2, 3, 4, 5, 6, 7, 8, 9, 10, 11, and 12, wherein the multilayer protective film has a thickness ratio PET-1_{T}:RL_{T} of not greater than about 4:1.

### Embodiment 16

The multilayer protective film or method of any one of embodiments 1, 2, 3, 4, 5, 6, 7, 8, 9, 10, 11, and 12, wherein the multilayer protective film has a thickness ratio PET-1_{T}:RL_{T} of at least about 1:10, where PET-1_{T} is equal to the average thickness of the first PET layer of the multilayer component and RL_{T} is equal to the average thickness of the release liner component.

### Embodiment 17

The multilayer protective film or method of any one of embodiments 1, 2, 3, 4, 5, 6, 7, 8, 9, 10, 11, and 12, wherein the release liner component has a thickness of at least about 35 microns.

### Embodiment 18

The multilayer protective film or method of any one of embodiments 1, 2, 3, 4, 5, 6, 7, 8, 9, 10, 11, and 12, wherein the release liner component has a thickness of not greater than about 300 microns.

### Embodiment 19

The multilayer protective film or method of any one of embodiments 1, 2, 3, 4, 5, 6, 7, 8, 9, 10, 11, and 12, wherein the multilayer protective film has an edge delamination time rating of at least about 10 hrs.

### Embodiment 20

The multilayer protective film or method of any one of embodiments 1, 2, 3, 4, 5, 6, 7, 8, 9, 10, 11, and 12, wherein the multilayer protective film has an edge delamination thickness rating of not greater than about 1.6 mm.

### Embodiment 21

The multilayer protective film or method of any one of embodiments 1, 2, 3, 4, 5, 6, 7, 8, 9, 10, 11, and 12, wherein the multilayer protective film has an edge optical distortion ratio EOD:COD of not greater than about 2:1, where EOD is equal to the optical distortion of the multilayer protective film measured within 1 inch of an outer edge of the multilayer protective film and COD is equal to the optical distortion of the multilayer protective film measured at the center of the multilayer protective film.

### Embodiment 22

The multilayer protective film or method of any one of embodiments 1, 2, 3, 4, 5, 6, 7, 8, 9, 10, 11, and 12, wherein the release liner component comprises a substrate component, and a release coating component attached to the substrate component between the substrate component and the multilayer component.

### Embodiment 23

The multilayer protective film or method of embodiment 22, wherein the substrate component comprises PET, polycarbonate, polyethylene variations, HDPE, LDPE, paper, fluoropolymer, ETFE, FEP or combinations thereof.

### Embodiment 24

The multilayer protective film or method of embodiment 23, wherein the substrate component has a thickness of at least about 25 microns.

### Embodiment 25

The multilayer protective film or method of embodiment 24, wherein the substrate component has a thickness of not greater than about 300 microns.

### Embodiment 26

The multilayer protective film or method of embodiment 22, wherein the release coating component comprises a silicone-based coating material, a fluoro-based coating material, an acrylic-based coating material, an acrylic-based coating material, a polyurethane-based coating material or combinations thereof.

### Embodiment 27

The multilayer protective film or method of embodiment 26, wherein the release coating component has a thickness of at least about 0.01 microns.

### Embodiment 28

The multilayer protective film or method of embodiment 27, wherein the release coating component has a thickness of not greater than about 10 microns.

### Embodiment 29

The multilayer protective film or method of embodiment 22, wherein the multilayer protective film further comprises and adhesive component between the multilayer component and the release liner component, and where the adhesive component comprises an acrylic-based adhesive, a silicone-based adhesive, a semi-permanent pressure sensitive adhesive, and combinations thereof.

### Embodiment 30

The multilayer protective film or method of embodiment 29, wherein the adhesive component has a thickness of at least about 2 microns.

### Embodiment 31

The multilayer protective film or method of embodiment 30, wherein the adhesive component has a thickness of not greater than about 30 microns.

### Embodiment 32

The multilayer protective film or method of any one of embodiments 1, 2, 3, 4, 5, 6, 7, 8, 9, 10, 11, and 12, wherein the multilayer protective film comprises an adhesion strength between the multilayer component and the release liner component of at least about 1 grams per inch as measure in a 180 degree peel.

### Embodiment 33

The multilayer protective film or method of embodiment 32, wherein the multilayer protective film comprises adhesion strength between the multilayer component and the release liner component of not greater than about 45 grams per inch as measure in a 180 degree peel.

### Embodiment 34

The multilayer protective film or method of any one of embodiments 1, 2, 3, 4, 5, 6, 7, 8, 9, 10, 11, and 12, wherein the first PET layer of the multilayer component has a thickness of at least about 5 microns.

### Embodiment 35

The multilayer protective film or method of embodiment 34, wherein the first PET layer of the multilayer component has a thickness of not greater than about 400 microns.

### Embodiment 36

The multilayer protective film or method of any one of embodiments 1, 2, 3, 4, 5, 6, 7, 8, 9, 10, 11, and 12, wherein the second PET layer of the multilayer component has a thickness of at least about 5 microns.

### Embodiment 37

The multilayer protective film or method of embodiment 34, wherein the second PET layer of the multilayer component has a thickness of not greater than about 400 microns.

### Embodiment 38

The multilayer protective film or method of any one of embodiments 1, 2, 3, 4, 5, 6, 7, 8, 9, 10, 11, and 12, wherein the multilayer component comprises at least about 3 PET layers.

### Embodiment 39

The multilayer protective film or method of embodiment 38, wherein the multilayer component comprises not greater than about 20 PET layers.

### Embodiment 40

The multilayer protective film or method of any one of embodiments 1, 2, 3, 4, 5, 6, 7, 8, 9, 10, 11, and 12, wherein the multilayer component further comprises a first multilayer component adhesive layer between the first PET layer and the second PET layer.

### Embodiment 41

The multilayer protective film or method of embodiment 40, wherein the first multilayer component adhesive layer comprises a non-permanent adhesive, an acrylic-based adhesive, a silicone-based adhesive, a semi-permanent pressure sensitive adhesive, and combinations thereof.

### Embodiment 42

The multilayer protective film or method of embodiment 41, wherein the first multilayer component adhesive layer has a thickness of at least about 3 microns.

### Embodiment 43

The multilayer protective film or method of embodiment 42, wherein the first multilayer component adhesive layer has a thickness of not greater than about 30 microns.

### Embodiment 44

The multilayer protective film or method of any one of embodiments 1, 2, 3, 4, 5, 6, 7, 8, 9, 10, 11, and 12, wherein the multilayer component further comprises at least one multilayer component adhesive layer between each pair of PET layers.

### Embodiment 45

The multilayer protective film or method of embodiment 44, wherein each multilayer component adhesive layer comprises a non-permanent adhesive, an acrylic-based adhesive, a silicone-based adhesive, a semi-permanent pressure sensitive adhesive, and combinations thereof.

### Embodiment 46

The multilayer protective film or method of embodiment 44, wherein each multilayer component adhesive layer has a thickness of at least about 3 microns.

### Embodiment 47

The multilayer protective film or method of embodiment 44, wherein each multilayer component adhesive layer has a thickness of not greater than about 30 microns.

### Embodiment 48

A pre-cut multilayer protective window film comprising: a multilayer component comprising a first PET layer overlying a second PET layer; and a release liner component underlying the multilayer component, wherein the multilayer protective film has a thickness ratio MPF_{T}:RL_{T} of not greater than about 14:1, where MPF_{T} is equal to the thickness of the multilayer component and RL_{T} is equal to the thickness of the release liner component, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 49

A pre-cut multilayer protective window film comprising: a multilayer component comprising a first PET layer overlying a second PET layer; and a release liner component underlying the multilayer component, wherein the multilayer protective film has a thickness ratio PET-1_{T}:RL_{T} of not greater than about 4:1, where PET-1_{T} is equal to the average thickness of the first PET layer of the multilayer component and RL_{T} is equal to the average thickness of the release liner component, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 50

A pre-cut multilayer protective window film comprising: a multilayer component comprising a first PET layer overlying a second PET layer; and a release liner component underlying the multilayer component, wherein the release liner component has a thickness of at least about 35 microns, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 51

A pre-cut multilayer protective window film comprising: a multilayer component comprising a first PET layer overlying a second PET layer; and a release liner component underlying the multilayer component, wherein the multilayer protective film has an edge delamination time rating of at least about 10 hrs, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 52

A pre-cut multilayer protective window film comprising: a multilayer component comprising a first PET layer overlying a second PET layer; and a release liner component underlying the multilayer component, wherein the multilayer protective film has an edge delamination thickness rating of not greater than about 1.6 mm, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 53

A pre-cut multilayer protective window film comprising: a multilayer component comprising a first PET layer overlying a second PET layer; and a release liner component underlying the multilayer component, wherein the pre-cut multilayer protective window film has an edge optical distortion ratio EOD:COD of not greater than about 2:1, where EOD is equal to the optical distortion of the multilayer protective film measured within 1 inch of an outer edge of the multilayer protective film and COD is equal to the optical distortion of the multilayer protective film measured at the center of the multilayer protective film, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 54

A method of forming a pre-cut multilayer protective window film, wherein the method comprises: providing a multilayer component comprising a first PET layer overlying a second PET layer; and applying a release liner component to the multilayer component to form a multilayer protective window film, and cutting the multilayer protective window film to form the pre-cut multilayer protective window film, wherein the pre-cut multilayer protective window film has a thickness ratio MPF_{T}:RL_{T} of not greater than about 14:1, where MPF_{T} is equal to the thickness of the multilayer component and RL_{T} is equal to the thickness of the release liner component, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 55

A method of forming a pre-cut multilayer protective window film, wherein the method comprises: providing a multilayer component comprising a first PET layer overlying a second PET layer; and applying a release liner component to the multilayer component to form a multilayer protective window film, and cutting the multilayer protective window film to form the pre-cut multilayer protective window film, wherein the pre-cut multilayer protective window film has a thickness ratio PET-1_{T}:RL_{T} of not greater than about 4:1, where PET-1_{T} is equal to the average thickness of the first PET layer of the multilayer component and RL_{T} is equal to the average thickness of the, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 56

A method of forming a pre-cut multilayer protective window film, wherein the method comprises: providing a multilayer component comprising a first PET layer overlying a second PET layer; and applying a release liner component to the multilayer component to form a multilayer protective window film, and cutting the multilayer protective window film to form the pre-cut multilayer protective window film, wherein the release liner component has a thickness of at least about 35 microns, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 57

A method of forming a pre-cut multilayer protective window film, wherein the method comprises: providing a multilayer component comprising a first PET layer overlying a second PET layer; and applying a release liner component to the multilayer component to form a multilayer protective window film, and cutting the multilayer protective window film to form the pre-cut multilayer protective window film, wherein the pre-cut multilayer protective window film has an edge delamination time rating of at least about 10 hrs, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 58

A method of forming a multilayer protective film, wherein the method comprises: providing a multilayer component comprising a first PET layer overlying a second PET layer; and applying a release liner component to the multilayer component, wherein the pre-cut multilayer protective window film has an edge delamination thickness rating of not greater than about 1.6 mm, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### Embodiment 59

A method of forming a multilayer protective film, wherein the method comprises: providing a multilayer component comprising a first PET layer overlying a second PET layer; and applying a release liner component to the multilayer component, wherein the pre-cut multilayer protective window film has an edge optical distortion ratio EOD:COD of not greater than about 2:1, where EOD is equal to the optical distortion of the multilayer protective film measured within 1 inch of an outer edge of the multilayer protective film and COD is equal to the optical distortion of the multilayer protective film measured at the center of the multilayer protective film, wherein the pre-cut multilayer protective window film has a pre-cut length of at least about 100 mm and not greater than about 3500 mm, and wherein the pre-cut multilayer protective window film has a pre-cut width of at least about 100 mm and not greater than about 3500 mm.

### EXAMPLES

The concepts described herein will be further described in the following Examples, which do not limit the scope of the invention described in the claims.

### Example 1

A sample multilayer protective film S1 was formed according to embodiments described herein. The sample multilayer protective film S1 included multilayer component and a release liner component. The multilayer component had the following construction: PET/Adhesive/PET/Adhesive/PET/Adhesive/PET/Adhesive. Each of the PET layers (i.e. PET) in the multilayer component had a thickness of 100 microns. Each of the adhesive layers (i.e., Adhesive) in the multilayer component included an acrylic adhesive and had a thickness of 8-10 microns. The release liner component had a thickness of 75 microns and included a silicon release layer.

A comparative sample multilayer protective film CS1 was formed form comparison to sample S1. The sample multilayer protective film CS1 included multilayer component and a release liner component. The multilayer component had the following construction: PET/Adhesive/PET/Adhesive/PET/Adhesive/PET/Adhesive. Each of the PET layers (i.e. PET) in the multilayer component had a thickness of 100 microns. Each of the adhesive layers (i.e., Adhesive) in the multilayer component included an acrylic adhesive and had a thickness of 8-10 microns. The release liner component had a thickness of 23 microns and included a silicon release layer.

The thickness ratios for Sample S1 and comparative sample CS1 are summarized in Table 1 below:

TABLE 1
Thickness Ratio Summary

| | MPF_{T} | RL_{T} | |
|---|---|---|---|
| Sample | (microns) | (microns) | MPF_{T}:RL_{T} |
| S1 | 440 | 75 | 5.9:1 |
| CS1 | 440 | 23 | 18.9:1 |

Sample S1 and comparative sample CS1 were tested to determine their distortion ratio, EDTHR and EDTR according to methods described herein. The results are summarized in Table 2 below.

TABLE 2
Performance Summary

| | Distortion | EDTHR | EDTR |
|---|---|---|---|
| Sample | Ratio | (mm) | (hours) |
| S1 | 1:1 | 0.2 | 48 |
| CS1 | N/A | 6.35 | 1 |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayer protective film comprising:
a multilayer component comprising a first PET layer overlying a second PET layer; and
a release liner component underlying the multilayer component,
wherein the multilayer protective film has a thickness ratio MPF_{T}:RL_{T} of not greater than about 14:1, where MPF_{T} is equal to the thickness of the multilayer component and RL_{T} is equal to the thickness of the release liner component.

2. The multilayer protective film of claim 1, wherein the multilayer protective film has a thickness ratio MPF_{T}:RL_{T} of not greater than about 14:1, where MPF_{T} is equal to the average thickness of the multilayer component and RL_{T} is equal to the average thickness of the release liner component.

3. The multilayer protective film of claim 1, wherein the multilayer protective film has a thickness ratio MPF_{T}:RL_{T} of at least about 1:7, where MPF_{T} is equal to the average thickness of the multilayer component and RL_{T} is equal to the average thickness of the release liner component.

4. The multilayer protective film of claim 1, wherein the multilayer protective film has a thickness ratio PET-1_{T}:RL_{T} of not greater than about 4:1.

5. The multilayer protective film of claim 1, wherein the multilayer protective film has a thickness ratio PET-1_{T}:RL_{T} of at least about 1:10, where PET-1_{T} is equal to the average thickness of the first PET layer of the multilayer component and RL_{T} is equal to the average thickness of the release liner component.

6. The multilayer protective film of claim 1, wherein the release liner component has a thickness of at least about 35 microns.

7. The multilayer protective film of claim 1, wherein the release liner component has a thickness of not greater than about 300 microns.

8. The multilayer protective film of claim 1, wherein the multilayer protective film has an edge delamination time rating of at least about 10 hrs.

9. The multilayer protective film of claim 1, wherein the multilayer protective film has an edge delamination thickness rating of not greater than about 1.6 mm.

10. The multilayer protective film of claim 1, wherein the multilayer protective film has an edge optical distortion ratio EOD:COD of not greater than about 2:1, where EOD is equal to the optical distortion of the multilayer protective film measured within 1 inch of an outer edge of the multilayer protective film and COD is equal to the optical distortion of the multilayer protective film measured at the center of the multilayer protective film.

11. The multilayer protective film of claim 1, wherein the release liner component comprises a substrate component, and a release coating component attached to the substrate component and between the substrate component and the multilayer component.

12. The multilayer protective film of claim 11, wherein the substrate component comprises PET, polycarbonate, polyethylene variations, HDPE, LDPE, paper, fluoropolymer, ETFE, FEP or combinations thereof.

13. The multilayer protective film of claim 12, wherein the substrate component has a thickness of at least about 25 microns.

14. A method of forming a multilayer protective film, wherein the method comprises:
providing a multilayer component comprising a first PET layer overlying a second PET layer; and
applying a release liner component to the multilayer component,
wherein the multilayer protective film has a thickness ratio MPF_{T}:RL_{T} of not greater than about 14:1, where MPF_{T} is equal to the thickness of the multilayer component and RL_{T} is equal to the thickness of the release liner component.

15. The method of claim 14, wherein the multilayer protective film has a thickness ratio MPF_{T}:RL_{T} of not greater than about 14:1, where MPF_{T} is equal to the average thickness of the multilayer component and RL_{T} is equal to the average thickness of the release liner component.

16. The method of claim 14, wherein the multilayer protective film has a thickness ratio MPF_{T}:RL_{T} of at least about 1:7, where MPF_{T} is equal to the average thickness of the multilayer component and RL_{T} is equal to the average thickness of the release liner component.

17. The method of claim 14, wherein the multilayer protective film has a thickness ratio PET-1_{T}:RL_{T} of not greater than about 4:1.

18. The method of claim 14, wherein the multilayer protective film has a thickness ratio PET-1_{T}:RL_{T} of at least about 1:10, where PET-1_{T} is equal to the average thickness of the first PET layer of the multilayer component and RL_{T} is equal to the average thickness of the release liner component.

19. The method of claim 14, wherein the release liner component has a thickness of at least about 35 microns.

20. A pre-cut multilayer protective window film comprising:
a multilayer component comprising a first PET layer overlying a second PET layer; and
a release liner component underlying the multilayer component,
wherein the multilayer protective film has a thickness ratio MPF_{T}:RL_{T} of not greater than about 14:1, where MPF_{T} is equal to the thickness of the multilayer component and RL_{T} is equal to the thickness of the release liner component,
wherein the pre-cut multilayer protective window film has a pre-cut length of at least about 100 mm and not greater than about 3500 mm, and
wherein the pre-cut multilayer protective window film has a pre-cut width of at least about 100 mm and not greater than about 3500 mm.
